(19) United States
(12) Patent Application Publication
(10) Pub. No.: US 2023/0243476 A1
(43) Pub. Date: Aug. 3, 2023

(54) APPARATUS AND METHOD FOR PRECIPITATION OF SOLIDS IN HYDROCARBON FLOW SYSTEMS

(71) Applicant: Empig AS, Trondheim (NO)

(72) Inventors: Lars S STROMMEGJERDE, Ranheim (NO); Thomas SPERLE, Ranheim (NO); Fredrik LUND, Trondheim (NO)

(21) Appl. No.: 18/008,286

(22) PCT Filed: May 31, 2021
(86) PCT No.: PCT/EP2021/064569

§ 371 Date: Dec. 5, 2022

(30) Foreign Application Priority Data
Jun. 5, 2020 (GB) 2008532.0

(51) Int. Cl. F17D 1/16; F17D 1/17; C10G 31/06

(52) U.S. Cl. CPC F17D 1/16; C10G 31/06; F17D 1/17

(57) ABSTRACT

The invention provides a cooler system for a hydrocarbon flow system and a method of use. The cooler system comprises a heat exchange conduit comprising a primary inlet for receiving a fluid to be cooled and a primary outlet. A return conduit is fluidly connected to the heat exchange conduit at a return location downstream of the primary inlet, and is configured to direct at least a proportion of fluid in the heat exchange conduit from the return location to a secondary cooler inlet system. The secondary cooler inlet system enables inflow of recycled fluid from the return conduit to the heat exchange conduit at a plurality of inflow positions along the hydrocarbon flow system, upstream of the return location. The method comprises flowing fluid into the hydrocarbon flow system at one or more of the plurality of inflow positions.

The present invention relates to an apparatus and method for precipitation of solids in hydrocarbon flow systems, and in particular to an apparatus and method of use which utilises techniques for seeding of precipitated solids by recycling fluid in a hydrocarbon fluid cooler system. Aspects of the invention include a cooler apparatus for a hydrocarbon flow system, methods of cooling a fluid in a hydrocarbon flow system, and a method of configuring a cooler apparatus for a hydrocarbon flow system. Aspects of the invention have particular application to subsea hydrocarbon flow systems in which seawater is the surrounding cooling medium in the heat exchange system. However, aspects of the invention also have application to cooler systems in other environments, including topsides or onshore active or passive cooler systems, in which the cooling medium in the heat exchange system may be water, air, or another cooling fluid such as glycol.

### BACKGROUND TO THE INVENTION

In the field of oil and gas production and transportation, flow assurance is a term used to relate to the various methods, technologies and strategies that ensure that the flow of hydrocarbons from the reservoir to the point of sale is uninterrupted. In shallow water or on onshore production environments, various flow assurance methods are known, including mechanical, thermal and chemical processes. Particular difficulties exist in subsea production environments, where deepwater and/or long flowlines between wellheads and subsea manifolds or production installations make flow assurance challenging, costly, and with high environmental impact. Current flow assurance technology represents the biggest cost driver in the oil and gas industry, and represents a limitation to pipeline reach and in the economics of field development.

A typical flow assurance problem addressed by the invention is the build-up of compounds including waxes and hydrates (and to a lesser extent, asphaltenes, higher paraffins, and combinations of these compounds), and/or scaling due to build-up of salts, minerals and sulphates. Hydrates that are naturally formed will be in the form of gas and water, forming a slurry phase (unstable) first then form a solid material or plug. Build-ups or deposits of such materials must be dealt with to reduce their impact on production rates and avoid clogging of the flowlines, pipes and production equipment.

Waxes start to form in a hydrocarbon fluid when the fluid cools to the Wax Appearance Temperature (WAT) of that fluid, or on a relatively cold pipe wall even when the bulk flow of fluid is above the WAT. Hydrates begin to form at the (pressure dependent) Hydrate Equilibrium Temperature (HET). Known methods of flow assurance include efforts to keep the flowing hydrocarbon warm and/or the formation of solids inhibited with chemicals such as mono-ethylene glycol (MEG). These methods require additional infrastructure such as flowline insulation, pipeline trenching, electrical heating, power supply, chemical injection and recovery points, injection lines/umbilicals, and/or cleaning regimes such as pipeline pigging and/or hot oil flushing from topsides. These known methods have various drawbacks, deficiencies, and limitations to their application, particularly in extreme pressures and temperatures, or over long flow distances, and can be high in cost.

Cold Flow methods are distinct from the methods by which the flowing hydrocarbon is kept warm and/or chemically inhibited; Cold Flow is generally known as the concept of cooling a hydrocarbon product down to ambient or near-ambient temperature, allowing one to transport the product in a cold, inert and stable state, without the need of chemical injection, thermal insulation on the pipes, or pipe heating and so on.

WO2004/059178 describes a method and system for transporting hydrocarbons in which the flow of hydrocarbons is mixed with another flowing fluid having a temperature below a crystallisation temperature for a precipitating solid.

US 2010/0300486 describes a cold flow system which includes the removal of precipitated wax from the inner surface of a pipeline wall by heating the inner wall for a short period of time to release the deposited wax.

WO2015/062878 describes a cold flow system which enables removal of wax and hydrate deposits by driving a vehicle bi-directionally on the cooling flowline.

Cold flow systems such as those described in the above-referenced documents all operate by cooling the hydrocarbon flow down to or very close to the ambient temperature of the environment surrounding the pipeline. In many applications, this will require large-scale cooler apparatus to fully cool the flowing hydrocarbons, limiting their economic and/or technical feasibility due to the high capital expenditure and operational burden of maintaining and cleaning the cooler.

It has been proposed to recycle cooled fluid from a remote side of an approximately 5 km long hydrocarbon transportation pipeline back to a near-well location on the pipeline, to shock cool the fluid flowing from the well in a mixing reactor and stimulate precipitation of hydrates in a dry and steady state into the bulk flow of fluid. This method had practical difficulties due to the length of the return pipeline, and was relatively inefficient as it required approximately 50% of the transported fluid to be recycled. The system would be difficult and expensive to install. It was unable to solve problems associated with wax precipitation, and had the drawback that any solids which are not precipitated into the bulk flow would result in deposits on the cool pipe walls, which could not then be easily removed.

### SUMMARY OF THE INVENTION

There is generally a need for an apparatus and method which addresses one or more of the flow assurance problems identified above.

It is amongst the aims and objects of the invention to provide an apparatus and method for precipitation of solids in hydrocarbon flow systems and which obviates or mitigates one or more drawbacks or disadvantages of the prior art.

In particular, one aim of an aspect of the invention is to provide an apparatus and/or method of use which improves the precipitation of solids, including but not limited to waxes and/or hydrates, in a hydrocarbon flow system.

Further aims and objects of the invention will become apparent from reading the following description.

According to a first aspect of the invention, there is provided a system for a hydrocarbon flow system, the cooler system comprising:
a heat exchange conduit comprising a primary inlet for receiving a fluid to be cooled and a primary outlet;
a return conduit, fluidly connected to the heat exchange conduit at a return location downstream of the primary inlet, and configured to direct at least a proportion of fluid in the heat exchange conduit from the return location to a secondary cooler inlet system;
wherein the secondary cooler inlet system enables inflow of recycled fluid from the return conduit to the heat exchange conduit at a plurality of inflow positions along the hydrocarbon flow system, upstream of the return location.

The secondary cooler inlet system may comprise a plurality of secondary cooler inlets configured to be located at a plurality of positions along a length of the hydrocarbon flow system, and each of the secondary cooler inlets may enable inflow of return fluid to the hydrocarbon flow system at a different position along the length of the hydrocarbon flow system.

The plurality of secondary cooler inlets may comprise at least one secondary cooler inlet downstream of the primary inlet of the heat exchange conduit. The plurality of secondary cooler inlets may comprise at least one secondary cooler inlet upstream of the primary inlet of the heat exchange conduit. For example, the at least one secondary cooler inlet may be provided at or close to a wellhead, Christmas tree, or flow system manifold.

The plurality of secondary cooler inlets may comprise at least one secondary cooler inlet at or near to the primary cooler inlet.

The secondary cooler inlet system may comprise a plurality of secondary cooler inlets located at a plurality of positions along a length of the heat exchange conduit. Each of the secondary cooler inlets may enable inflow of return fluid to the heat exchange conduit at a different position along the length of the heat exchange conduit.

In one embodiment, the secondary cooler inlet system comprises a plurality of secondary cooler inlets, and the secondary cooler inlet system is operable to provide inflow of return fluid at each of the plurality of secondary cooler inlets. Thus the system may enable fluid inflow at the plurality of inflow positions along the hydrocarbon flow system simultaneously and/or in parallel. By providing multiple inflow positions simultaneously, the likelihood of providing return fluid inflow at or near an optimal position (i.e. a position that is effective at facilitating precipitation of a solid into the bulk flow of the fluid) along the hydrocarbon flow system or heat exchange conduit for the seeding of one or more precipitated compounds is increased. The system may therefore facilitate the precipitation and/or crystallisation of solids of any form into the bulk flow of fluid by delivering catalytic nuclei particles to an appropriate location or locations in the flow system.

In an alternative embodiment, the secondary cooler inlet system may enable inflow of return fluid to the hydrocarbon flow system at one or more positions selected from the plurality of available inflow positions. The selected one or more positions may be optimised for seeding of one or more precipitated compounds from the fluid to be cooled.

Preferably, the secondary cooler inlet system enables inflow of return fluid to the heat exchange conduit at two or more positions along the hydrocarbon flow system, for example, between the primary cooler inlet and the outlet conduit. The two or more positions may respectively comprise two or more inflow positions for the seeding of two or more precipitated compounds from the fluid to be cooled. For example, the secondary cooler inlet system may enable inflow of return fluid to the heat exchange conduit at a first position for seeding of a wax compound from the fluid to be cooled, and a second position for seeding of a hydrate compound from the fluid to be cooled. In some configurations, optimal inflow positions for two more precipitated solids may coincide. A first position for seeding of a wax compound from the fluid to be cooled may be upstream of second position for seeding of a hydrate compound from the fluid to be cooled, or may be downstream. Relative positions of the first and second positions may change if the selected inflow positions are adjusted or reconfigured.

In one embodiment, the secondary cooler inlet system may enable inflow of return fluid to the heat exchange conduit at a first position optimised for seeding of a wax compound from the fluid to be cooled, and a second position optimised for seeding of a hydrate compound from the fluid to be cooled.

In practice, there may be a degree of uncertainty in a desired inflow position for a seeding of one or more precipitated compounds from the fluid to be cooled. In one embodiment, the secondary cooler inlet system may enable inflow of return fluid to the heat exchange conduit at a first plurality of inflow positions and a second plurality of inflow positions. The first plurality of inflow positions may be a plurality of inflow positions for the seeding of a first precipitated compound from the fluid to be cooled, and the second plurality of inflow positions may be a plurality of inflow positions for the seeding of a second precipitated compound from the fluid to be cooled. For example, the first plurality of positions may be for seeding of a wax compound from the fluid to be cooled, and a second plurality of positions may be for seeding of a hydrate compound from the fluid to be cooled.

The secondary cooler inlet system may comprise one or more flow control components, for controlling inflow of return fluid to the one or more inflow positions. The one or more flow control components may comprise one or more valves. The apparatus may comprise a control module in communication with the one or more valves. Alternatively, or in addition, the one or more flow control components may comprise one or more flow control orifices.

The secondary cooler inlet system may comprise a plurality of inlet conduits disposed between the return conduit and the heat exchange conduit, wherein each inlet conduit is disposed at a different location along a length of the heat exchange conduit.

The secondary cooler inlet system may comprise a manifold disposed between the return conduit and the heat exchange conduit. The plurality of inlet conduits may be disposed between the manifold and the heat exchange conduit. Alternatively, or in addition, the secondary cooler inlet system may comprise a plurality of individual return flow lines, and/or a plurality of individual flow lines splitting or emanating from a common return flow line.

The one or more flow control components may comprise a valve or a flow control orifice in each of the inlet conduits.

The secondary cooler inlet system may be operable to change one or more inflow positions in response to a changed condition of the apparatus and/or fluid to be cooled. The secondary cooler inlet system may be operable to add a further inflow position to an existing inflow position. Alternatively, or in addition, the secondary cooler inlet system may be operable to change an inflow position.

The valves may be operable to selectively direct return fluid to one or more inflow positions. The valves may be operable to close a first inflow position, and open a second inflow position in response to a changed condition of the apparatus and/or fluid to be cooled. One or more valves may be operable to control a flow rate in their respective inlets. As such the valves may be partially opened/closed to adjust the flow rate at any given inflow position between a fully closed position and a fully open position.

The apparatus may comprise one or more sensors.

The apparatus may comprise one or more pressure sensors, which may be configured for measuring a pressure in the fluid to be cooled, and/or a pressure differential across at least a portion of the apparatus.

The apparatus may comprise one or more temperature sensors, which may be configured for measuring temperature at one or more positions along the length of the heat exchange cooler. The temperature sensors may comprise external temperature sensors. Alternatively, or in addition, the temperature sensors may comprise internal temperature sensors.

In a preferred embodiment of the invention, the cooler apparatus is used in conjunction with a cleaning system, configured to remove deposits of precipitated solids from the inner walls of the conduit system. The cleaning system may be incorporated into the cleaning apparatus or may be a separate cleaning system of a known type, that is integrated with the cooler apparatus.

The cleaning system may be operable to remove deposits of precipitated solids from the inner walls of one or more of the heat exchange conduit, the return conduit, and/or conduits of the secondary cooler inlet system.

The cleaning system may be located externally of the conduits of the cooler apparatus to be cleaned. For example, the cleaning system may comprise inductive heating elements, electrical trace heating elements, and/or hot fluid trace heating conduits located externally of the conduits to be cleaned. Alternatively, or in addition, the cleaning system may comprise a hot fluid flushing system, configured to direct a relatively hot fluid (for example hot oil) through conduits to be cleaned in order to remove deposits of precipitated solids from the inner walls of the conduits, internal electrical trace heating elements, internal hot fluid trace heating conduits, or pipe-in-pipe flow systems.

The cleaning system may be configured to heat one or more conduits of the cooler apparatus during a heating phase of operation of the cooler apparatus. Preferably the cleaning system is configured to heat one or more conduits of the cooler apparatus cyclically, or during multiple discrete time intervals, repeated during operation of the cooler apparatus.

The cleaning system may comprise one or more modules movable along the exterior of the conduit to be cleaned and heat the conduit. The cleaning system may comprise induction heating elements.

The apparatus may comprise a return conduit cleaning system for cleaning or otherwise mitigating against build-up of deposits on the conduit, for example an internal pig, heat tracing elements, or a hot oil flushing system.

The cooler apparatus may be a subsea cooler apparatus. Alternatively, the cooler apparatus may be a topsides or onshore cooler apparatus.

According to a second aspect of the invention, there is provided a method of cooling a fluid in a hydrocarbon flow system, the method comprising:
flowing a fluid to be cooled through a cooler apparatus comprising a heat exchange conduit between a primary inlet and a primary outlet;
at a return location downstream of the primary inlet, directing at least a proportion of flowing fluid into a return conduit and to a secondary cooler inlet system;
wherein the secondary cooler inlet system enables inflow of recycled fluid from the return conduit at a plurality of inflow positions along the hydrocarbon flow system, upstream of the return location, and the method comprises flowing recycled fluid into the hydrocarbon flow system at one or more of the plurality of inflow positions.

The method may comprise flowing return fluid at a plurality of inflow positions along the hydrocarbon flow system simultaneously and/or in parallel. By providing multiple inflow positions simultaneously, the likelihood of providing return fluid inflow at or near an optimal position along the hydrocarbon flow system for the seeding of one or more precipitated compounds is increased.

The method may comprise selecting one or more inflow positions along the hydrocarbon flow system selected from the plurality of available inflow positions. The selected one or more positions may be optimised for seeding of one or more precipitated compounds from the fluid to be cooled.

The method may comprise flowing return fluid to the hydrocarbon flow system at two or more positions along the heat exchange conduit between the primary cooler inlet and the cooler outlet. The two or more positions may respectively comprise two or more inflow positions for the seeding of two or more precipitated compounds from the fluid to be cooled. For example, the method may comprise flowing return fluid to the hydrocarbon flow system at a first position for seeding of a wax compound from the fluid to be cooled, and a second position for seeding of a hydrate compound from the fluid to be cooled.

The method may comprise optimising the inflow position of a return fluid for seeding of a wax compound from the fluid to be cooled, and/or may comprise optimising the inflow position of a return fluid for seeding of a hydrate compound from the fluid to be cooled.

In practice, there may be a degree of uncertainty in a desired inflow position for a seeding of one or more precipitated compounds from the fluid to be cooled. In one embodiment, the method may comprise flowing return fluid to the hydrocarbon flow system at a first plurality of inflow positions and a second plurality of inflow positions. The first plurality of inflow positions may be a plurality of inflow positions for the seeding of a first precipitated compound from the fluid to be cooled, and the second plurality of inflow positions may be a plurality of inflow positions for the seeding of a second precipitated compound from the fluid to be cooled.

The method may comprise operating one or more valves to control the inflow of return fluid to the one or more inflow positions. The method may comprise operating one or more valves via a control panel in communication with the one or more valves.

The method may comprise changing one or more inflow positions in response to a changed condition of the apparatus and/or fluid to be cooled. The method may comprise adding or opening a further inflow position to an existing inflow position. Alternatively, or in addition, the method may comprise changing an inflow position.

The method may comprise monitoring the cooler apparatus via one or more sensors.

The sensors may comprise one or more pressure sensors, and the method may comprise measuring a pressure in the fluid to be cooled, and/or a pressure differential across at least a portion of the apparatus.

The method may comprise providing pressure data to a processor. The method may comprise processing or analysing the pressure data to verify performance of the cooler apparatus. The method may comprise processing or analysing the pressure data to identify built-up solids in the cooler apparatus. The method may comprise changing an inflow position based on processing or analysis of the pressure data.

The sensors may comprise one or more temperature sensors, and the method may comprise measuring a temperature at one or more positions along the length of the heat exchange cooler. The temperature sensors may comprise external temperature sensors. Alternatively, or in addition, the temperature sensors may comprise internal temperature sensors.

The method may comprise providing temperature data to a processor. The method may comprise processing or analysing the temperature data to verify performance of the cooler apparatus. The method may comprise processing or analysing the temperature data to identify built-up solids in the cooler apparatus. The method may comprise changing an inflow position based on processing or analysis of the temperature data.

The selected one or more positions may be selected in dependence on a fluid characteristic. The fluid characteristic may be a fluid characteristic known from a fluid sample taken prior to, or during, operation of the cooler apparatus.

Embodiments of the second aspect of the invention may include one or more features of the first aspect of the invention or its embodiments, or vice versa.

According to a third aspect of the invention, there is provided a method of cooling a fluid in a hydrocarbon flow system, the method comprising:
flowing a fluid to be cooled through a cooler apparatus comprising a heat exchange conduit between a primary inlet and a primary outlet;
at a return location downstream of the primary inlet, directing at least a proportion of flowing fluid into a return conduit and to a secondary cooler inlet system;
flowing recycled fluid into the hydrocarbon flow system at a first one or more inflow positions during a first phase of operation;
and flowing recycled fluid into the hydrocarbon flow system at a second one or more inflow positions during a second phase of operation, the second one or more inflow positions along the hydrocarbon flow system being different from the first one or more inflow positions.

The second one or more inflow positions may comprise at least one inflow position that is different from the first one or more inflow positions. Therefore the second one or more inflow positions may comprise a changed inflow position, and/or an additional inflow position, that was not comprised in the first one or more inflow positions.

Alternatively, the first one or more inflow positions may comprise a first set of inflow positions, and the second one or more inflow positions may comprise a subset of the first set of inflow positions. Therefore the second one or more inflow positions may comprise a reduced number of inflow positions.

The method may comprise changing the one or more inflow positions in dependence on a fluid characteristic, which may be a calculated or estimated fluid characteristic.

The method may comprise changing the one or more inflow positions in response to a change in a fluid characteristic or a reservoir characteristic. The change in fluid characteristic may be a predicted change in a fluid or reservoir characteristic or a measured change in a fluid or reservoir characteristic. The change in the characteristic may be measured from a collected sample of fluid, and/or may be measured by an inline measurement of a fluid.

The method may comprise changing the one or more inflow positions in response to a measurement of pressure. The method may comprise measuring a pressure in the fluid to be cooled, and/or a pressure differential across at least a portion of the cooler apparatus.

The method may comprise providing pressure data to a processor. The method may comprise processing or analysing the pressure data to verify performance of the cooler apparatus. The method may comprise processing or analysing the pressure data to identify built-up solids in the cooler apparatus. The method may comprise changing an inflow position based on processing or analysis of the pressure data.

The method may comprise changing the one or more inflow positions in response to a measurement of temperature. The method may comprise measuring a temperature at one or more positions along the length of the heat exchange cooler. The temperature sensors may comprise external temperature sensors. Alternatively, or in addition, the temperature sensors may comprise internal temperature sensors.

The method may comprise providing temperature data to a processor. The method may comprise processing or analysing the temperature data to verify performance of the cooler apparatus. The method may comprise processing or analysing the temperature data to identify built-up solids in the cooler apparatus. The method may comprise changing an inflow position based on processing or analysis of the temperature data.

The method may comprise cleaning at least a portion of the hydrocarbon flow system or the cooler apparatus.

The method may comprise cleaning at least portion of the hydrocarbon flow system or cooler apparatus by heating deposits formed on an inner wall of the hydrocarbon flow system or cooler apparatus, to dislodge the deposits from the inner wall of the hydrocarbon flow system or cooler apparatus.

The method comprises heating deposits formed on an inner wall of the or cooler apparatus from an exterior of the cooler apparatus, preferably by induction heating.

Embodiments of the third aspect of the invention may include one or more features of the first or second aspects of the invention or their embodiments, or vice versa.

According to a fourth aspect of the invention, there is provided a method of cooling a fluid in a hydrocarbon flow system, the method comprising:
flowing a fluid to be cooled through a cooler apparatus comprising a heat exchange conduit between a primary inlet and a primary outlet;
at a return location downstream of the primary inlet, directing at least a proportion of flowing fluid into a return conduit and to a secondary cooler inlet system;
flowing recycled fluid into the hydrocarbon flow system at a first one or more inflow positions during a first phase of operation;
and flowing recycled fluid into the hydrocarbon flow system at a second one or more inflow positions during a second phase of operation, the second one or more inflow positions along the hydrocarbon flow system being different from the first one or more inflow positions.

Embodiments of the fourth aspect of the invention may include one or more features of the first to third aspects of the invention or their embodiments, or vice versa.

According to a fifth aspect of the invention there is provided a method of configuring a cooler system for a hydrocarbon flow system, the cooler system comprising:
a heat exchange conduit comprising a primary inlet for receiving a fluid to be cooled and a primary outlet;
a return conduit, fluidly connected to the heat exchange conduit at a return location downstream of the primary inlet, and configured to direct at least a proportion of fluid in the heat exchange conduit from the return location to a secondary cooler inlet system;
wherein the secondary cooler inlet system enables inflow of recycled fluid from the return conduit to the heat exchange conduit at a plurality of inflow positions along the hydrocarbon flow system, upstream of the return location;
the method comprising:
inputting data to a processor module, the input data comprising:
fluid data relating to at least one characteristic of a fluid to be cooled; and system data relating to the operation of the cooler system;
determining, using a cooler apparatus model running on the processor module and the input data, one or more inflow positions from the plurality of inflow positions along the hydrocarbon flow system.

The system data may comprise cooler geometry data relating to the cooler apparatus, cooler performance data, and/or environmental data relating to ambient conditions in which the cooler is to operate.

The method may comprise determining a second one or more inflow positions along the heat exchange cooler during a second phase of operation, the second one or more inflow positions along the hydrocarbon flow system being different from the first one or more inflow positions.

The method may comprise changing the one or more inflow positions in dependence on a fluid characteristic, which may be a calculated or estimated fluid characteristic.

Within the scope of the invention, inputting data to a processing module, and/or determining one or more inflow positions, or may be performed in a remote location from the cooler system, including in another international jurisdiction.

Embodiments of the fifth aspect of the invention may include one or more features of the first to fourth aspects of the invention or their embodiments, or vice versa.

According to a sixth aspect of the invention there is provided a method of cooling a fluid in a hydrocarbon flow system, the method comprising:
configuring a cooler apparatus according to the method of the fifth aspect of the invention; flowing a fluid to be cooled through the cooler apparatus;
directing at least a proportion of fluid away from the cooler outlet and to the secondary cooler inlet system; and
flowing fluid into the hydrocarbon flow system at the one or more of the plurality of inflow determined by the processor module.

Embodiments of the sixth aspect of the invention may include one or more features of the first to fifth aspects of the invention or their embodiments, or vice versa.

According to a seventh aspect of the invention, there is provided a cooler apparatus for a hydrocarbon flow system, the cooler apparatus comprising:
a primary cooler inlet for receiving a fluid to be cooled;
a heat exchange conduit in fluid communication with the primary cooler inlet;
an outlet conduit downstream of the heat exchange conduit;
a return conduit, fluidly connected to the outlet conduit, and configured to direct at least a proportion of fluid in the outlet conduit to a secondary cooler inlet system, downstream of the primary cooler inlet;
wherein the secondary cooler inlet system enables inflow of return fluid to the heat exchange conduit at a plurality of inflow positions along the heat exchange conduit between the primary cooler inlet and the outlet conduit.

Embodiments of the seventh aspect of the invention may include one or more features of the first to fifth aspects of the invention or their embodiments, or vice versa.

### BRIEF DESCRIPTION OF THE DRAWINGS

There will now be described, by way of example only, various embodiments of the invention with reference to the drawings, of which:

FIG. 1 is a schematic representation of a hydrocarbon flow system incorporating a cooler apparatus in accordance with a first embodiment of the invention;

FIG. 2 is a schematic representation of a cooler apparatus in accordance with an alternative embodiment of the invention;

FIG. 3A is a schematic representation of a cooler apparatus in accordance with an alternative embodiment of the invention in a first phase of operation;

FIG. 3B is a schematic representation of the cooler apparatus of FIG. 3A in a second phase of operation;

FIG. 4 is a schematic representation of a cooler apparatus in accordance with an alternative embodiment of the invention;

FIG. 5 is a flow diagram representative of a mode of operation of a cooler system in accordance with an embodiment of the invention;

FIG. 6 is a schematic representation of an experimental configuration useful for understanding the invention;

FIG. 7 is a plot of a typical pressure differential in a cooler system for baseline, partial system and full system conditions;

FIG. 8 is a plot of a typical pressure differential in a cooler system for baseline, partial system and full system conditions including different seeding points, and;

FIG. 9 is a schematic representation of a hydrocarbon flow system incorporating a cooler apparatus in accordance with an alternative embodiment of the invention.

### DETAILED DESCRIPTION OF PREFERRED EMBODIMENTS

The invention in its various aspects has particular application to hydrocarbon cooler systems for use below the surface of the sea to cool fluid produced from a subsea well, and accordingly the following description relates to subsea applications in which the cooler system is disposed on the seabed with seawater as the cooling medium in the heat exchange system. However, the invention also has application to cooler systems in other environments, including topsides or onshore active or passive cooler systems such as those on unmanned wellhead platforms (“UWPs”). The cooling medium in the heat exchange system may be water, air, or another cooling fluid such as glycol.

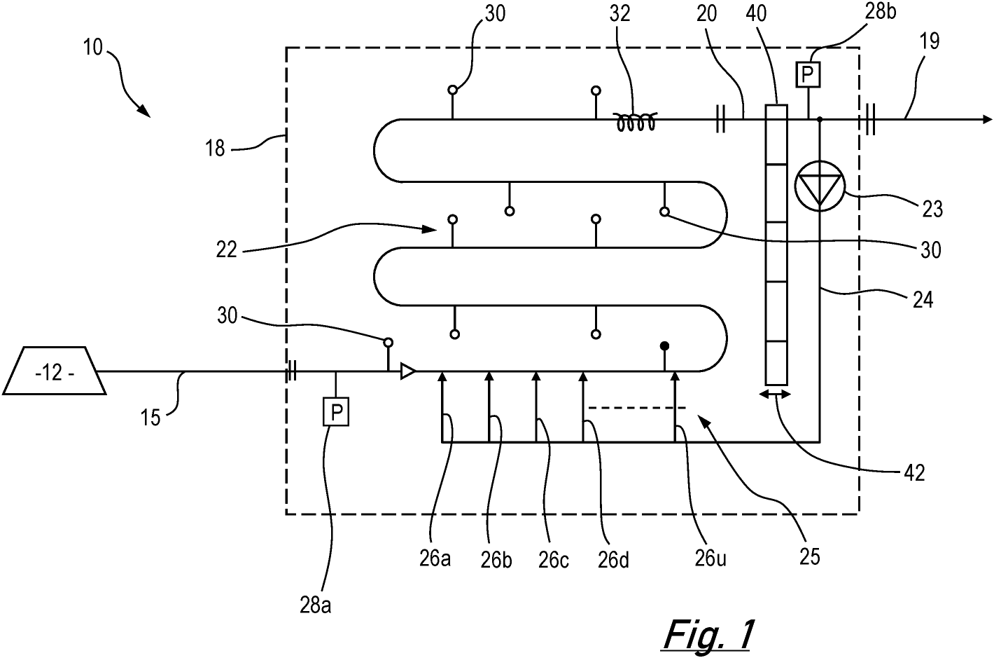

Referring firstly to FIG. 1, there is shown generally at 10 a hydrocarbon flow system comprising a subsea wellhead 12, a cooler apparatus 18, and an export flowline 19. The system 10 transports fluids produced from a subsea well to a Floating Production, Storage and Offloading vessel, platform or other production facility (which may be offshore or onshore). In the system 10 of this embodiment, produced fluids pass from the wellhead 12 to the cooler apparatus 18 via the cooler inlet conduit 15.

The fluid in the cooler inlet conduit 15 typically has a temperature higher than the ambient temperature of the subsea environment, and will tend to cool as it flows to the production facility, with a tendency to precipitate solids such as waxes and hydrates during its transport, at risk to flow assurance. The cooler apparatus 18 is designed to precipitate all (or a significant proportion of) wax and hydrate within the cooler such that fluid entering the export flowline does not have (or has only limited) potential for further formation of wax and hydrate. The cooler apparatus also causes the precipitation in of solids from salts, sulphates and minerals that are associated with scale build-up, reducing the potential for scale forming on the export flowlines.

The cooler apparatus comprises a heat exchange conduit 22, in fluid communication with inlet conduit 15 and an outlet conduit 20. The heat exchange conduit 22 has a Nominal Pipe Size of 3 inches and an outer diameter of approximately 89 mm, and in this embodiment is formed from a standard carbon steel material. Other suitable dimensions include Nominal Pipe Size 2 to 6 inches (outer diameters in the range of around 60 mm to 168 mm), and suitable materials include stainless steels, titanium, and other thermally conductive materials. The materials used may also be electrically conductive (e.g. where used in conjunction with inductive heating cleaning methods as described below), or may be electrically insulating or non-conductive, such as in polymer or composite pipe systems where inductive cleaning is not required in the system. The total length of the heat exchange conduit 22 is in this embodiment 1000 m, but in general the length of the cooling pipes is selected dependent on factors including inlet temperature, preferred outlet temperature, whether the cooling is passive or active, and water cut (%) in the fluid to be cooled, and can typically be in the range of 200 m to 2000 m.

Between the cooler inlet conduit and the outlet conduit is a return conduit 24, which is in fluid communication with the cool side of the heat exchange conduit and provides a return flow path for cooled fluid to be recycled to a secondary inlet system, generally depicted at 25. The return conduit comprises a pump 23. The return fluid or recycled fluid contains solid particles already precipitated into the fluid through the cooling process, and these solid particles function as a catalyst or “seeds” for further precipitation of solids into the bulk fluid flowing in the heat exchange conduit. The secondary inlet system enables inflow to the heat exchange conduit 22 at any of a number of inflow positions 26a, 26b, 26c, 26d, ..., 26n (generally 26) along the length of the heat exchange conduit. The inflow positions 26 are inlet conduits longitudinally spaced along the heat exchange conduit, generally disposed towards the warm side of the of the cooler apparatus (i.e. closer to the inlet conduit 15 than the outlet conduit 20. Optionally the return conduit and/or the inlet conduits comprise check valves (not shown) to prevent flow from the warm side of the cooler into the return conduit. In this example, the inflow positions are distributed over the first 50 m to 150 m of the heat exchange conduit, but in general the inflow positions will typically be distributed over the first 2% to 15% of the total length, although this is dependent on the temperature of the produced hydrocarbons. Any number of inflow positions greater than one may be provided depending on the required distribution, but typically a number between 2 and 12 inflow positions (inclusive) will be a reasonable balance between sensitivity and complexity of the system.

The optimum seeding point for a given flow system is determined by the temperature of the fluid in the heat exchange conduit, which is of course affected by the longitudinal position along the conduit. If the recycled fluid from the return conduit enters the heat exchange conduit too close to the cooler inlet, the solid particles in the already cooled return fluid that are desired to act as catalysts for further precipitation will melt, as the temperature of the bulk fluid in the heat exchange conduit will be too high (i.e. higher than the Wax Appearance Temperature (WAT) and the Hydrate Equilibrium Temperature (HET). Conversely, if the recycled fluid from the return conduit enters the heat exchange conduit too far from the cooler inlet, the temperature of the bulk fluid in the heat exchange conduit will be too low, and layers of precipitated wax or hydrate will already be forming on the inner wall of the conduit. The WAT and the HET are different from one another, meaning that the optimum seeding points for wax and hydrate are different, even though the wax and hydrate seeds are recycled together.

In the simple configuration of this embodiment of the invention, the inflow positions 26 are all open to return flow, and fluid returning from the cool side of the heat exchange conduit is able to flow into the heat exchange conduit at each of the inflow positions. By providing multiple inflow positions simultaneously, the likelihood of providing return fluid inflow at or near an optimal position along the heat exchange conduit for the seeding of wax and hydrates or other precipitated compounds is increased. Seeding of the precipitated compounds is therefore improved with respect to a conventional seeding system which has a single fixed position for inflow of return fluid. Such a configuration is suitable for a system that is relatively insensitive to changes to seeding points, but may not be suitable in all applications. The use of multiple open seeding lines requires a relatively high percentage of fluid to be recycled through the return line, which has implications for cooler length, capacity of the return pump, and general efficiency of the system. In other embodiments of the invention fewer inflow positions may be favoured (as described below).

The cooler apparatus 18 is also provided with a cleaning system, generally depicted at 40, which functions to remove deposits of precipitated solids from the inner walls of the conduit system. In this embodiment, the cleaning system 40 comprises one or more modules movable in the direction of the arrows 42 to translate along the exterior of the heat exchange conduit and heat the conduit by induction heating. Heating of the conduit causes heating and flaking of the adhering surfaces wax deposits on the inner walls of the conduits to dislodge the deposits as particles into the bulk flow of the fluid. The cleaning system optionally includes means for cleaning the exterior of the conduits (e.g. removal of fouling), such as water jetting, brushes or scrapers, as the conduits are passed. An example of a suitable cleaning system is described in the applicant’s patent publication number WO2015/062878, although the apparatus and methods of the invention are suitable for use with any of a range of cleaning systems. Examples of possible cleaning systems include cleaning system located externally of the conduits of the cooler apparatus to be cleaned. For example, the cleaning system may comprise inductive heating elements, electrical trace heating elements, and/or hot fluid trace heating conduits, any of which may be located externally of the conduits to be cleaned.

Alternatively, or in addition, the cleaning system may comprise a hot fluid flushing system, configured to direct a relatively hot fluid (for example hot oil) through conduits to be cleaned in order to remove deposits of precipitated solids from the inner walls of the conduits.

In a preferred implementation of the cleaning system, cleaning of the conduits is cyclical. In this example, the movable inductive heating module undergoes regular or irregular, repeated reciprocating motion over the cooler apparatus to heat and dislodge solid deposits as the heating apparatus moves along the conduit system.

The improved seeding of the apparatus and embodiments of the present invention can reduce the deposit rates of by up to approximately 90%. This provides greater flexibility in the choice of cleaning regime and/or the way a cleaning system is operated. For example, the frequency of cleaning operations can be reduced, and/or a lower impact cleaning system may be used. Reducing cleaning frequency will reduce power consumption which again will reduce the operating expense of the system, and may also reduce maintenance costs of the cleaning system due to reduced wear on the equipment used.

The cooler apparatus 18 optionally comprises pressure sensors 28a, 28b (together 28) and/or temperature sensors 30. The pressure sensors 28a and 28b are respectively located at, adjacent, or near the cooler inlet conduit 15 at, adjacent or near the outlet conduit 20. They are capable of measuring pressure of the fluid in the cooler conduits, and outputting pressure data to a processor (not shown). The processor may be local to the system or may be remotely located, for example as part of a subsea control module or at a surface facility. The pressure data may be processed to measure and optionally monitor over time a differential pressure over the cooler conduit system. An increase in the differential pressure over the cooler conduits will be indicative of a build up of solids on the inner walls of the conduits, which can be indicative of an incorrect or sub-optimal seeding point in the system. Conversely, a stable differential pressure can be indicative of effective seeding in the system to avoid or mitigate solid build ups. Over a period of operation which includes at least one cleaning cycle, a stable differential pressure with no upward trend in the pressure drop indicates that the cleaning system is able to remove deposits as fast as the deposits accumulate (within a time period of a cleaning cycle there may be some fluctuations in differential pressure caused by the continuous growing and removal of deposition at different locations in the cooler). Pressure data can also be used to control and/or adjust the seeding point in embodiments of the invention (to be described below).

The temperature sensors 30 are distributed over the length of the heat exchange conduit and are capable of measuring the temperature of the exterior of the conduit and outputting temperature data to the processor. The temperature data may be processed to measure and optionally monitor over time the external temperature of the conduit system. Decreased external temperatures may be indicative of reduced heat transfer through the walls of the conduit, due to build up of thermally insulating wax and/or hydrate on the inner wall of the conduit. Conversely, a stable temperature profile can be indicative of effective seeding in the system to avoid or mitigate solid layer build ups. Over a period of operation which includes at least one cleaning cycle, a stable temperature with no downward trend indicates that the cleaning system is able to remove deposits as fast as the deposits accumulate (although within a time period of a cleaning cycle there may be some local fluctuations in temperature caused by the continuous growing and removal of deposition at different locations in the cooler). Temperature data can also be used to control and/or adjust the seeding point in embodiments of the invention (to be described below).

The temperature data may be used as an alternative to or in addition to the pressure data. It should be appreciated that other locations of pressure and temperature sensors are within the scope of the invention. For example, pressure sensors may be located at positions along the length of conduit system, so that pressure differentials can be measured and monitored over parts of the length of the conduit. Alternatively, or in addition, embodiments of the invention may use internal temperature sensors instead of, or used together with, the external temperature sensors as described above. When using internal temperature sensors, increased internal temperatures may be indicative of reduced heat transfer through the walls of the conduit, due to build-up of wax and/or hydrate on the inner wall of the conduit.

The cooler apparatus may optionally include a formation or insertion 32 configured to disrupt the flow in at least a portion of conduit system of the cooler apparatus. The insertion may be, for example, a helical coil or swirl disposed in the heat exchange conduit, and may be designed to induce turbulence in the flow. Turbulence and fluid mixing can increase the heat exchange coefficient and therefore the effectiveness of the cooler. In addition, the turbulence and fluid mixing can increase the erosion of wax layers on the inner walls of the conduit; the abrasiveness of solid particles in the fluid assists in wearing down any wax layers. The insertion could extend through the entire or majority of the cooler apparatus. One potential drawback is that the differential pressure over the cooler would be increased. Another is the potential for the insertion to become clogged by deposits of precipitated solids, so for certain applications (such as long subsea tie-backs), the formation may be localised to selected zones to increase the heat transfer coefficient at those areas. In other applications, such formations and insertions may be located in parts of the conduit that can be effectively cleaned, to reverse the effect of clogging, and in others, formations and insertions may be omitted.

The system 10 is able to address a number of issues with conventional wax and/or hydrate seeding systems. Firstly, the multiple seeding points increase the likelihood of providing seeding optimised for both wax and hydrates, at or near to the WAT and HET (which as noted above can be different). Secondly, although an optimum seeding point for a fluid can be estimated or calculated based on WAT and HET and other characteristics of the fluid or system (estimated, modelled or measured), this cannot be done without an error margin. In addition, the recycled fluid introduces a small local temperature change in the fluid, which requires the optimum seeding points to be slightly above the WAT and HET, introducing further complexity and uncertainty into the system.

The optimum seeding point can also change through the production lifetime of a well. For example, a virgin well will produce fluids having different properties as it pulls fluid from different reservoir sections. Depletion of higher pressure zones will change composition of the fluid over time, resulting in (for example) changes in the composition of the liquid hydrocarbons produced from different reservoir sections, or occurrence of gas breakthrough and/or water breakthrough during production. The WAT and HET will change, and the optimum seeding points can move as a consequence. Temperature of the produced fluids will also change, in dependence on the contribution from different reservoir sections, and also from gas and water breakthroughs. The optimum seeding inflow positions will therefore change over time. By providing multiple seeding points, the inflow of recycled fluid is more likely to take place near or close to an optimum seeding point. The system therefore has improved robustness with respect to changes over time, changes in conditions, and error margins.

A further advantage of the system is that it can be used effectively for new wells tied into subsea slots and templates at a later time, based on a standard or standardised design. Thus the cooler apparatus may be used with a subsea well, and when abandoned, new wells can be tied into the flow system and the cooler can be reused. The cooler apparatus is robust enough to handle variations in production parameters such as variations to fluid composition, pressure and temperature.

The system also effectively reduces scaling problems, caused by the build-up of salts, minerals and sulphates, for example in conjunction with water re-injection. The seeding promotes crystallisation of the solid particles in the bulk fluid, rather than the formation of scale on the conduit surfaces.

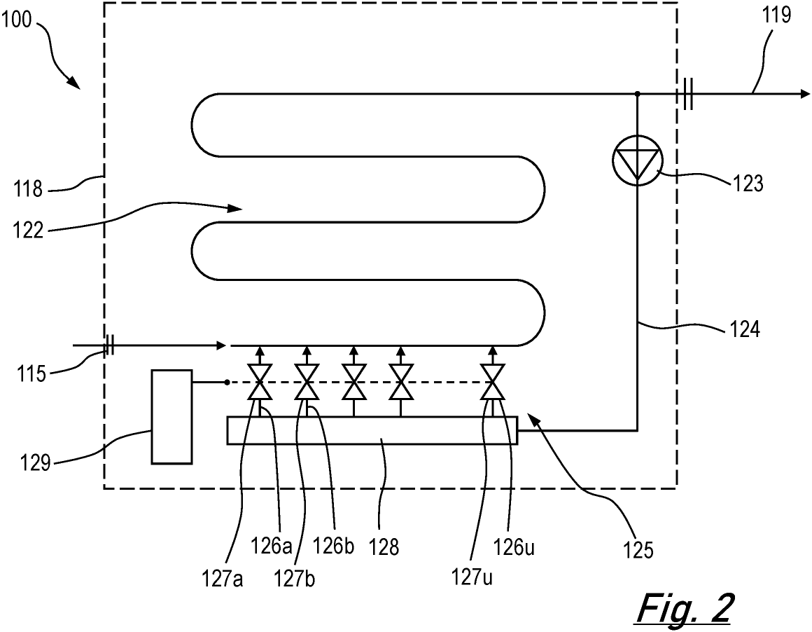

Referring now to FIG. 2, there is shown generally at 100 a cooler system in accordance with a particular embodiment of the invention. The system 100 comprises a cooler inlet conduit 115, a cooler apparatus 118, and an export flowline 119, and is similar in function and application to the system 10 of FIG. 1. The cooler apparatus 118 includes a heat exchange conduit 122, and a return conduit 124 with a pump 127, enabling fluid to be returned or recycled to a secondary inlet system 125 having a number of inflow positions 126a, 126b, ..., 26n (generally 126) along the length of the heat exchange conduit.

Various optional features, included in the system 10, may also be included in system 100, but are omitted from FIG. 2 for simplicity of the drawing. Such features may include but are not limited to an upstream oil/water separator, pressure sensors, temperature sensors, a flow disrupting formation, inlet check valves, and a cleaning system, all of which are described with reference to FIG. 1, are also applicable to the operation of the system 100.

The system 100 differs from the system 10 in that the secondary cooler inlet system 125 includes a number of inlet control valves 127a, 127b, ..., 127n (together 127) disposed in the inlet conduits 126 at the inflow positions, between the heat exchange conduit 122 and a return fluid manifold 128 receiving fluid from the return conduit 124.

The inlet control valves are operable to selectively open and close to enable return fluid to flow into the heat exchange conduit at a selected one or more of the inflow positions 126. The valves 127 are controlled by a control module 129, which in this embodiment is local to and part of the cooler apparatus 118. The control module 129 includes a valve control system and a processor (not shown) configured to receive and process data relating to the operating parameters of the system. Such operating parameters include but are not limited to pressure data and temperature data collected from the cooler system as described above. In alternative embodiments the control module and/or valve control module may be remotely located, for example as part of a subsea control module or at a surface facility.

The system 100 is operable to select one or more active inflow positions from the available set of inflow positions 126 to improve and/or optimise seeding or precipitated solids.

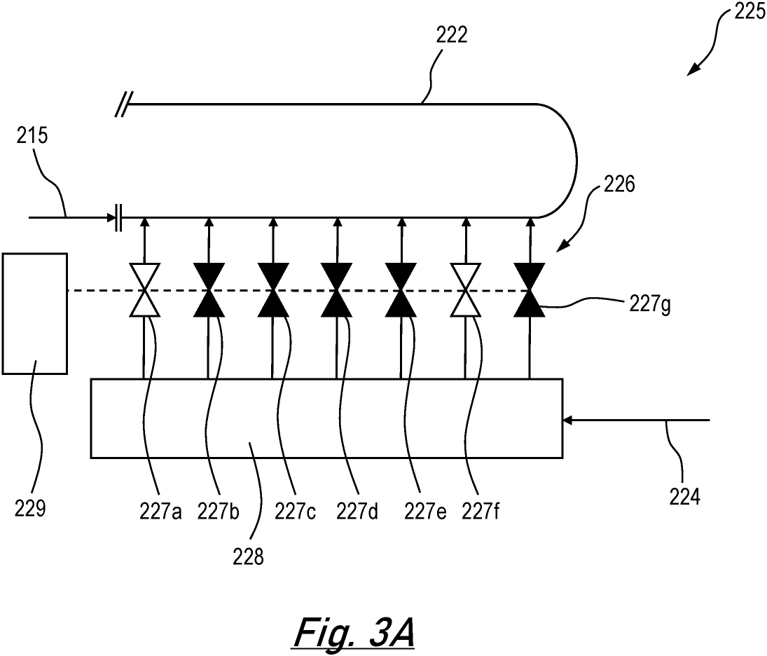

FIGS. 3A and 3B are schematic representations of a secondary inlet system 225 of a cooler apparatus similar to the cooler apparatus 118 in operation (details of the cooler apparatus and wider flow system are omitted for simplicity). The secondary inlet system 225 has seven inlet conduits 226 arranged along the heat exchange conduit 222 relatively close to the inlet conduit 215, defining a set of possible inflow positions. The inlet conduits receive recycled fluids from a return conduit via a manifold 228. Each inlet conduit has an inlet valve 227a to 227g (together 227), controlled by a valve control system in a control module 229.

In the condition shown in FIG. 3A, inlet valves 227a and 227f are open, enabling return fluid to flow into the heat exchange conduit at two inflow positions displaced along the heat exchange conduit 222. Inlet valves 227b, 227c, 227d, 227e, and 227g are closed. The open/closed status of the valves is selected to optimise the seeding points for the precipitation of wax solids and hydrate solids respectively. Such selection is estimated or calculated based on WAT and HET and other characteristics of the fluid or system (estimated, modelled or measured), taking account of a small local temperature change in the fluid introduced by the recycled fluid. The optimised seeding points improve the precipitation of solids into the bulk flow of fluid passing through the heat exchange conduit during cooling.

FIG. 3B shows the secondary inlet system 225 at a later time, in a different operating condition. In FIG. 3B, the inflow positions have been changed in response to a change in optimal seeding points for the precipitation of each of wax and hydrate solids, for example due to a change in the fluid composition. The change in fluid composition may be detected through fluid sampling or inline fluid analysis (although in other embodiments may be predicted based on production modelling or empirical data). In the condition shown in FIG. 3B, inlet valves 227b and 227g are open, enabling return fluid to flow into the heat exchange conduit at two inflow positions displaced along the heat exchange conduit 222. Inlet valves 227a, 227c, 227d, 227e, and 227f are closed. The selection of seeding points is estimated or calculated based on WAT and HET and other measured or calculated characteristics of the fluid or system to maintain the precipitation of solids into the bulk flow of fluid.

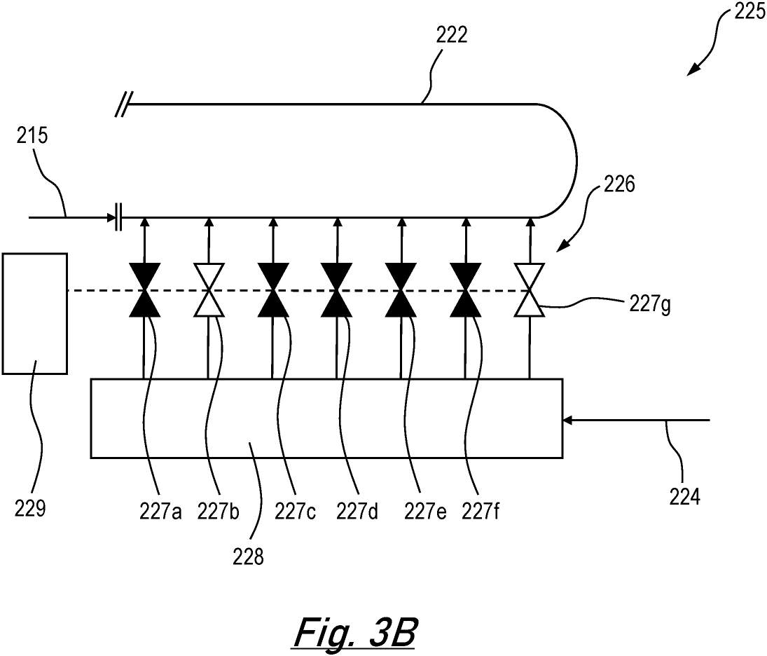

FIG. 4 is a schematic representation of a secondary inlet system 325 of a cooler apparatus similar to the cooler apparatus 118 in operation (again, details of the cooler apparatus and wider flow system are omitted for simplicity). In this example, the secondary inlet system 325 has eight inlet conduits 326 arranged along the heat exchange conduit 322 relatively close to the inlet conduit 315, defining a set of possible inflow positions. The inlet conduits receive recycled fluids from a return conduit via a manifold 328, and each inlet conduit has an inlet valve 327a to 327h (together 327), controlled by a valve control system in a control module 329.

Operation of the secondary inlet system 325 is similar to the secondary inlet system 225, and will be understood from FIGS. 1 to 3B and the accompanying description. However, in the operating condition shown in FIG. 4, inlet valves 327b, 327c, 327g, and 327h are open, enabling return fluid to flow into the heat exchange conduit at four inflow positions displaced along the heat exchange conduit 322. Inlet valves 327a, 327d, 327e, and 327f are closed. The inlet valves 327b and 327c are on adjacent inlets, as are inlet valves 327g, and 327h, and define two adjacent pairs of inflow positions corresponding to temperatures in the heat exchange conduit 322 at or near to the WAT and HET respectively. This configuration therefore enables inflow at two positions for seeding of wax, and two positions for seeding of hydrates. As described above, although an optimum seeding point for a fluid can be estimated or calculated based on WAT and HET and other characteristics of the fluid or system (estimated, modelled or measured), this cannot be done without an error margin, and the provision of multiple inflow positions for each of wax and hydrate seeding increases the likelihood of providing seeding optimised for both wax and hydrates.

Although two inflow positions are provided for each of wax seeding and hydrate seeding, it should be appreciated that greater than two inflow positions may be used for seeding of one or both solids, and the number of inflow positions utilised for each seeding point may not be equal. In addition, multiple seeding points may be utilised for precipitation of one solid, in combination with a single seeding point for precipitation of another solid. In many applications, the system will not be highly sensitive to the seeding point, and a small inaccuracy will not be noticeable when melting times and temperature variations due to the introduction of the cooler recycled fluid are taken into account.

It will be understood that where multiple inflow positions are used for seeding each of wax and hydrate as shown in FIG. 4, the positions can be changed in response to a change in optimal seeding points for the precipitation of each of wax and hydrate solids, for example due to a change in the fluid composition. Although the change of inflow positions between FIGS. 3A and 3B is the exchange of a single inflow position for seeding of each solid with another single inflow position, other changes are within the scope of the invention, including the opening of additional inlets to provide additional inflow positions, and/or the closing of a subset of inlets to reduce the number of inflow positions for seeding of a given solid.

In the modes of operation described above, optimum seeding points for a fluid can be estimated or calculated based on WAT and HET and other characteristics of the fluid or system, which may themselves be estimated, modelled or measured. The systems of the invention may also be monitored to verify the performance of the cooler system, to verify that the selected seeding points are optimised, and/or to determine or implement changes to the seeding points as follows.

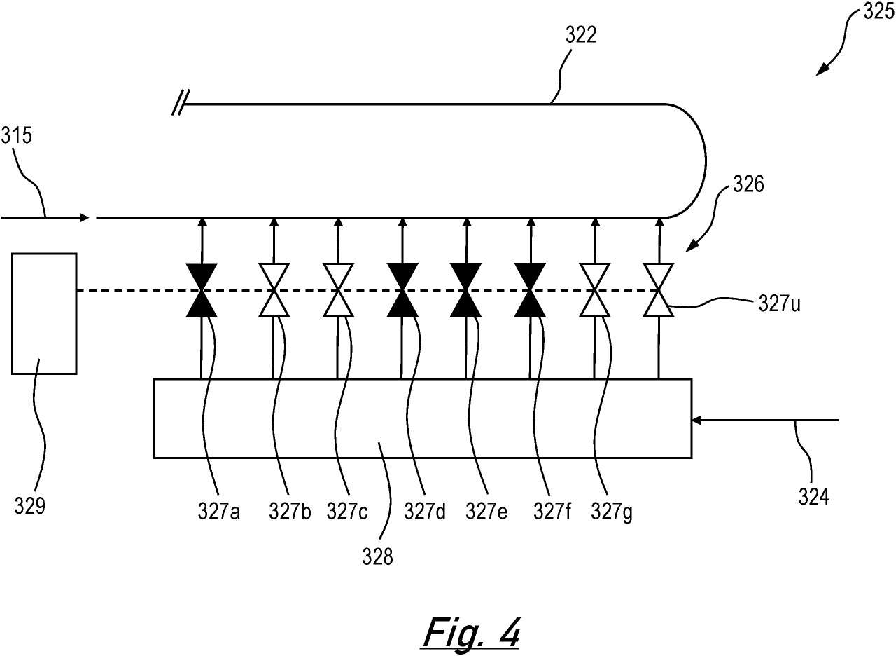

FIG. 5 is a flow diagram representative of a mode of operation of a cooler system in accordance with an embodiment of the invention, such as the cooler system 100 of FIG. 2 incorporating temperature and pressure sensors, as described with reference to FIG. 1. The method, generally depicted at 500, uses a processor 510 to determine optimum seeding points for precipitation of one or more solids (step 512), and select inflow positions (step 514) from available inflow positions (126, FIG. 2). The processor 510 may be implemented in software, or may be implemented in dedicated hardware (for example a hardware processing module forming a part of a cooler apparatus itself). Inputs to the processor 510 include fluid data 501 relating to characteristics of the fluid flowing through the cooler system (including but not limited to fluid composition, temperature, pressure and flow rate) and system data 502 including but not limited to environmental data relating to ambient conditions in which the cooler system is to operate, cooler geometry and/or performance data, and cooling targets for the flow system downstream of the cooler. The fluid data 501 may be estimated or calculated based on production modelling, and/or may be determined from analysis of samples or inline fluid measurements.

When the inflow positions have been selected (514), the cooler apparatus 118 is operated (516) to flow the fluid through the system from the inlet conduit 115 to the export flowline 119. Cooler operation includes opening and closing (step 517) of valves 127a-127n and operation of the pump 123 to drive return fluid from the cool side of the cooler to the secondary inlet system 125 via the return conduit 124.

During operation of the cooler, pressure sensors optionally measure pressure of the fluid in the cooler conduits (step 520), and send pressure data to the processor 510. The pressure data may be processed to monitor over time a differential pressure over the cooler conduit system. An increase in the differential pressure over the cooler conduits will be indicative of a build-up of solids on the inner walls of the conduits, which can be indicative of an incorrect or sub-optimal seeding point in the system. Conversely, a stable or slowly changing differential pressure can be indicative of effective seeding in the system to avoid or mitigate solid build ups.

In addition, or as an alternative, temperature sensors distributed over the length of the heat exchange conduit optionally measure the temperature (step 530) of the exterior of the conduit and send temperature data to the processor 510. The temperature data may be processed to measure and optionally monitor over time the external temperature of the conduit system. Reduced external temperatures may be indicative of reduced heat transfer through the walls of the conduit, due to build-up of wax and/or hydrate on the inner wall of the conduit. If internal temperature sensors are used instead of, or together with, the external temperature sensors, increased internal temperatures may be indicative of reduced heat transfer through the walls of the conduit, due to build-up of wax and/or hydrate on the inner wall of the conduit. Conversely, a stable or slowly changing temperature profiles can be indicative of effective seeding in the system to avoid or mitigate solid layer build ups.

Fluid data 501 and/or system data 502 may be updated over time (i.e. updated fluid data and/or system data may be input into the processor regularly during operation of the system on in response to a predicted or detected event that is expected to give rise to a material change).

Based on changes to fluid data and or system data, and/or indications from pressure and/or temperature measurements taken from the cooler system, calculations are updated in the processor to determine updated seeding points (512) and select updated inflow positions (514). Desired changes to the inflow positions are implemented by control of the valves (step 517) to enable inflow positions that optimise seeding of precipitated solids.

Updates to the fluid data 501, system data 502, and pressure and/or temperature data may be at regular intervals, to provide regular update to the selected seeding points. In some embodiments of the invention, updates can be high frequency or continuous to enable optimisation of seeding points in real time.

### Example

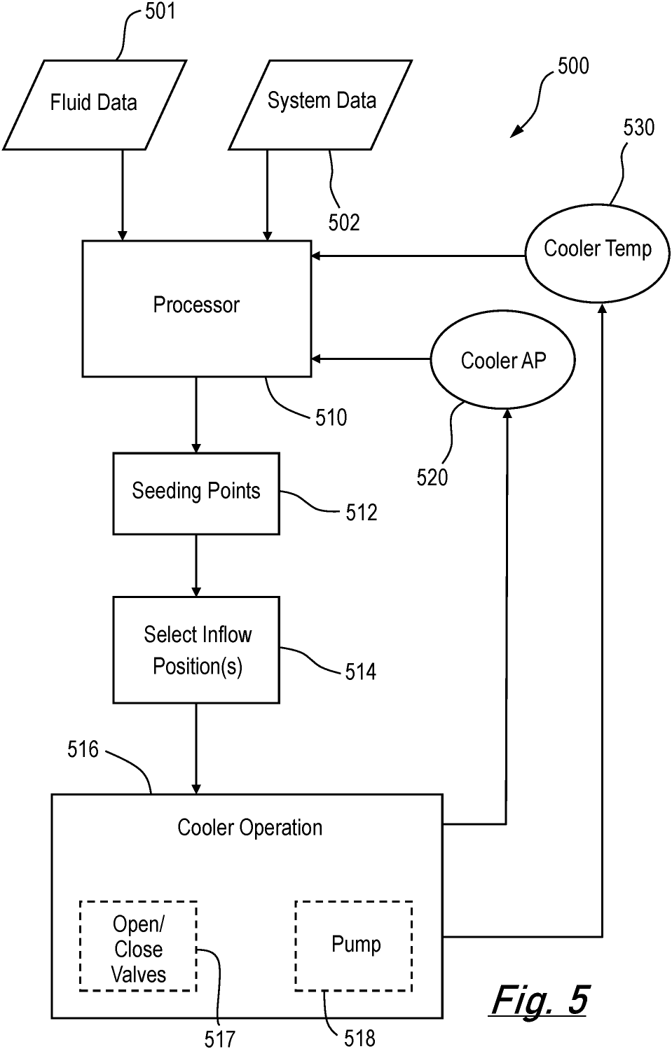

The principles of the invention have been successfully demonstrated in an experimental set-up using a multiphase flow loop. The experimental configuration is shown generally in FIG. 6 at 600 in simplified form, and is very close to the commercial scale. Oil from a field on the Norwegian continental Shelf was used, providing testing at very realistic conditions. The configuration 600 includes a cooler 602 comprising a 300 m long 2 inch Nominal Pipe Size pipe (60 mm outer diameter, 49 mm inner diameter) 603 located in a container 604 with circulating river water as the heat exchange medium. Pumps 606 and 608 supply hot oil and water from a separator/reservoir 610 to the cooler, and as the hot oil and water is cooled down, wax and gas hydrate deposits were formed on the pipe wall, and a slurry with gas hydrates and wax particles passes out of the cooler. A pipe-in-pipe heat exchanger connected to a steam boiler 612 heats and reconditions the cold slurry to reservoir temperature before the fluids are returned to the separator. The separator separates the phases, and also functions as a fluid reservoir. (A small gas compressor 614 was also installed to allow circulation of free gas, but it was not used in the experiments.) The cooler was heavily instrumented with temperature and pressure sensors (not shown), and was provided with a robotic induction heating system (not shown) to remove deposition. A return line 616 for seeding using cold recirculated slurry was split off from just downstream the cooler. Two injection ports for seeding of cold slurry are located at different positions along the cooler.

Downstream of the cooler, a 25 mm (1 inch) loop was provided for testing of slurry properties; a jacketed pipe-in-pipe section allowed simulation of different downstream seabed temperatures. This section could be pigged to measure wax deposition quantities.

A control system (not shown) monitored all the measured parameters and regulates the fluid rates and temperatures, enabling unmanned, continuous operation of the set-up. This was connected to an alarm system that automatically shut down parts or all of the set-up if necessary. All parameters were logged continuously at a sampling rate of 2 Hz.

The experimental configuration was used to carry out several different experiments, which can be grouped into three categories: baseline tests, with no removal of wax and hydrate deposits; partial system tests where seeding was employed with no cyclical heating; and complete system tests with both seeding and cyclical induction heating.

### Results

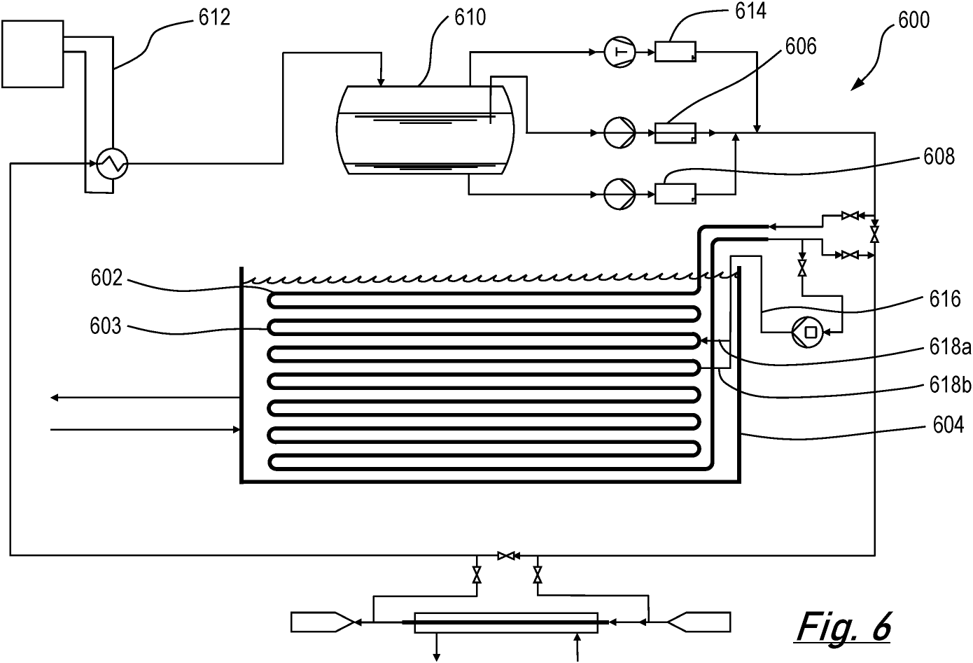

Baseline tests were run with no seeding or removal of wax and hydrates during the tests, to investigate how wax and hydrate depositions would emerge in a system with no remediation. Hot fluids from the separator, with temperature between 62 - 65° C., entered the cooler and were cooled to 8 - 14° C. (depending on river water temperature, which was used for external cooling of the pipes). After passing through the cooler, the fluids were reheated to above 65 to 70° C. before returning to the separator. In all baseline tests, deposits were detected shortly after start-up. The pressure drop through the cooler increased, and the temperatures at the outside of the pipe wall decreased. The deposits of wax and hydrates were allowed to build up for several hours. Repetitions were performed and showed very similar results. Some of the tests were run for a longer time, until the pressure drop increased to a level that stopped the pumps from operating. In a baseline test with both wax and hydrates, and 5% water cut, the cooler was almost plugged after 7.5 hours and completely plugged after 12 hours. In a baseline test with wax alone, the cooler was plugged after around 6 hours. After each test, the container was emptied of water and hot oil circulated to melt the deposits. Typical pressure drop development for experimental baseline tests with a wax-containing fluid is shown in FIG. 7 at line A.

Partial system tests were carried out using seeding of particles, by recycling approximately 15% of the main flow in the cooler. Injection ports for seeding were located at 40 m, 66 m and 108 m from the start of the cooler. FIG. 7 line B shows the pressure drop development for a wax-containing fluid when the seeding point at 40 m was used. The pressure drop through the cooler increased, and the temperatures at the outside of the pipe wall decreased, with a very similar profile to the baseline test. The results indicate that wax seeding was ineffective at 40 m, as the temperature of the fluid was too high. In contrast, FIG. 7 line C shows the pressure drop development for the wax-containing fluid when the seeding point at 108 m was used. The pressure drop through the cooler increased, and the temperatures at the outside of the pipe wall decreased, but much more slowly than the baseline test and the test when the 40 m seeding point was used. The results indicate that seeding in the wax-containing fluid was improved at 108 m. However, the data show that there is a gradual increase in pressure drop as the cooler system is left to run, which in time could be cause the conduit to be completely plugged.

In the complete system tests, both seeding and sequential induction scan heating were in operation.

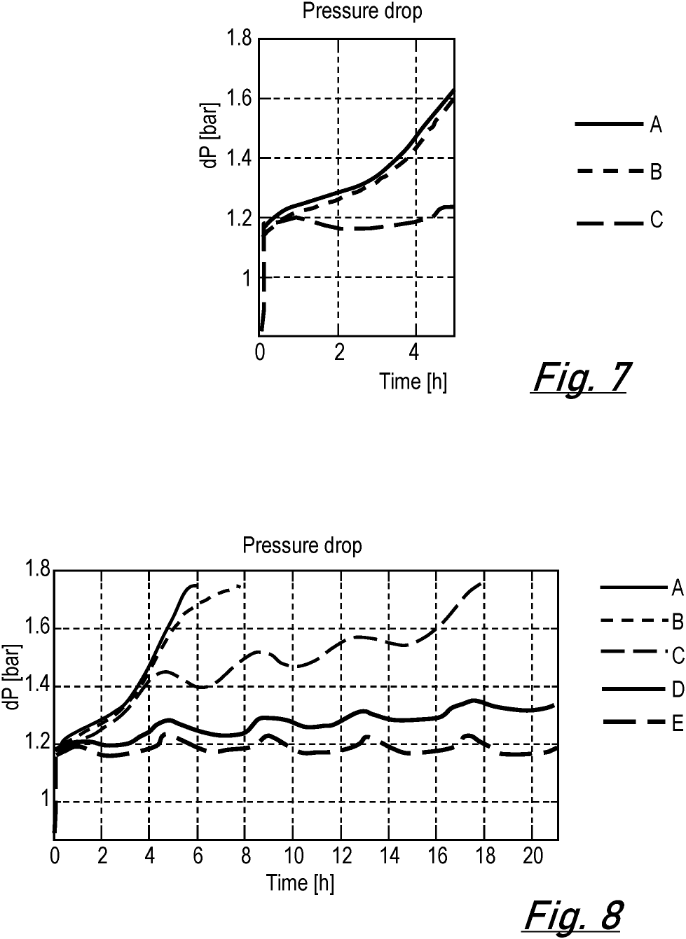

FIG. 8 is derived from experimental testing of a wax-containing fluid flowing in the system of FIG. 6. Line A is a graphical representation of the pressure development for a wax-containing fluid with no seeding, and corresponds to line A of FIG. 7.

FIG. 8 line B shows a typical pressure drop development using seeding through the ineffective seeding point at 40 m with no cleaning. Deposition is indicated by the increasing pressure drop, with a very similar profile to the baseline test (plotted as line A), but with some extension of the time that the pumps were able to run before the pressure drop increased to a level that was too great.

FIG. 8 line C shows a typical pressure drop development over a long term test using seeding through the ineffective seeding point at 40 m with cyclical cleaning. Deposition and pressure drop development is similar to line B, but shortly after the cleaning robot passed by, the pressure drop decreases significantly as deposits are removed by the cleaning process. However, the cyclical cleaning alone is insufficient to remove all of the deposits in the absence of effective seeding, and the pressure drop is not brought back to its initial values. Over a long-term test, there is an upward trend in the pressure drop, indicating that the robot in the absence of effective seeding is unable to remove deposition as fast as the deposition grew.

FIG. 8 line D shows a typical pressure drop development over a long term test using seeding through a partially effective seeding point with cyclical cleaning. Deposition and pressure drop development is similar to line C, with lower peaks as the deposition of solids is reduced by the seeding process. Over a long term test, the pressure drop is kept below a level that is too high for the pumps to operate, but there is a slight upward trend in the pressure drop that indicates that with only partially effective seeding the cleaning robot is unable to remove deposition as fast as the deposition grows.

FIG. 8 line E shows a typical pressure drop development over a long term test using seeding through the effective seeding point at 108 m. Some deposition could be seen from the increasing pressure drop, but shortly after the cleaning robot passed by, the pressure drop was back to the initial values. Over a long term test, there was no upward trend in the pressure drop, indicating that the robot in combination with the seeding was able to remove deposition as fast as the deposition grew. The fluctuations in line E are caused by the continuous growing and removal of deposition at different locations in the cooler.

Although the results shown in FIGS. 7 and 8 are derived from experimental tests with hydrocarbon fluids containing wax only, similar results were obtained from experimental testing using hydrocarbon fluids containing hydrates and wax, as the deposition mechanisms and thermodynamic effects are similar.

The foregoing embodiments describe how a proportion of cooled fluids can be recycled from a return location to one or more selected inflow locations upstream of the return location to facilitate precipitation of solids by seeding. The described systems may also be used in a shut-in circulation mode to reduce or avoid the formation of hydrate plugs in the system. In a shut-in (or production shut-down) mode, all of the fluid passing through the cooler is circulated back to one or more inflow locations, without production fluid entering the system. The fluid with dry hydrate particles passes through return conduit pump and circulates in the system, with the effect of homogenising the mixture, reducing the propensity for hydrates to form, and facilitating a safe restart of production after the shut-in period. Alternatively, or in addition, the systems can be operated in a circulation mode prior to start-up of production, to homogenise the fluids in the system.

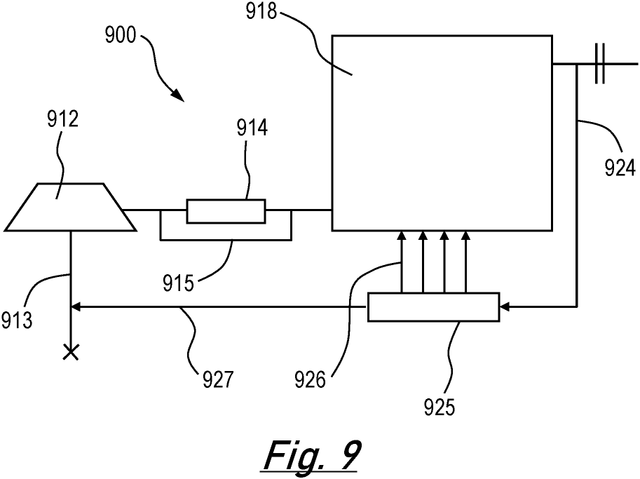

Referring now to FIG. 9, there is shown a schematic representation of a hydrocarbon flow system incorporating a cooler apparatus in accordance with an alternative embodiment of the invention. The system, generally depicted at 900, is similar to the systems 10 and 100, and its features and operation will be understood from FIGS. 1 and 2 and the accompanying description. Certain features of the system 900 have been omitted form the drawing for brevity. The system 900 comprises a subsea wellhead 912 on a subsea well 913. An export flowline transports fluids produced from the subsea well to a Floating Production, Storage and Offloading vessel, platform or other production facility (which may be offshore or onshore). In the system 900 of this embodiment, produced fluids pass from the wellhead 912 to the cooler apparatus 918 via a water separator 914 or bypass conduit 915.

The cooler apparatus comprises a heat exchange conduit (not shown) and a return conduit 924, which is in fluid communication with the cool side of the heat exchange conduit and provides a return flow path for cooled fluid to be recycled to a secondary inlet system, generally depicted at 925. The return conduit comprises a pump (not shown). The secondary inlet system enables inflow to the heat exchange conduit at any of a number of inflow positions (generally 926) along the length of the heat exchange conduit.

The system 900 differs from the systems 10 and 100 in that it comprises an additional return fluid inlet 927 at an inflow location upstream of the heat exchange conduit of the cooler 918. In this embodiment, the inflow position is upstream of the wellhead 912, but in alternative embodiments, inflow positions directly into the wellhead, or between the wellhead and the inlet conduits to the cooler may be used (and indeed multiple upstream inflow positions may be provided, and may be selectable prior to or during operation).

The return fluid inlet 927 (or multiple inlets in other embodiments) enables recycled fluid to be flowed through a part of the system upstream of the cooler, to provide the benefits of seeding in those parts of the system. This is particularly beneficial during periods of production shut down, in which no production fluid is flowing from the subsea well. Fluids present in the flow system will cool over time, with a risk of solid precipitation in the conduits upstream of the cooler, including the wellhead, as the temperature reaches the WAT or the HET. Conventionally this problem is addressed by chemical treatment of the fluid conduits in or near the wellhead, but the system of FIG. 9 enables recycled fluid with solid particles to be circulated through the near-wellhead conduits and/or the wellhead equipment itself to stimulate the precipitation of solids into the bulk fluid and reduce build up on the conduit walls. This circulation of recycled fluid can be continuous or intermittent throughout the shut-in and/or restart period, with the selective use of the inlet(s) 927 controlled by flow control mechanisms as with earlier-described embodiments. The system 900 may also be operated in a shut-in circulation mode with the effect of homogenising the mixture of fluids and solid particles, reducing the propensity for hydrates to form and facilitating a safe restart or start-up of production.

In a further variation, the system is provided with a fluid return inlet at an inflow location downstream of the heat exchange conduit of the cooler, which may be an alternative to or in addition to an upstream fluid inlet such as the inlet 927 of system 900. In such a variation, fluid can be circulated via the return conduit through a downstream flow loop, to avoid settling or deposits and/or plug formations in downstream equipment during periods of shut-in or ceased production, and/or to homogenise the fluid in the flow loop ready for start-up or restart. In the circulation modes described, fluid may be pumped to circulate through a single one, more than one, or all of the flow loops created from the return conduit, the secondary inlet system, and the additional upstream and/or downstream fluid inlets (where present), and the system may be provided with valves to control the desired circulation paths through the flow system.

The invention provides a cooler system for a hydrocarbon flow system and a method of use. The cooler system comprises a heat exchange conduit comprising a primary inlet for receiving a fluid to be cooled and a primary outlet. A return conduit is fluidly connected to the heat exchange conduit at a return location downstream of the primary inlet, and is configured to direct at least a proportion of fluid in the heat exchange conduit from the return location to a secondary cooler inlet system. The secondary cooler inlet system enables inflow of recycled fluid from the return conduit to the heat exchange conduit at a plurality of inflow positions along the hydrocarbon flow system, upstream of the return location. The method comprises flowing fluid into the hydrocarbon flow system at one or more of the plurality of inflow positions.

The invention facilitates the precipitation and/or crystallisation of solids of any form into the bulk flow of fluid by delivering catalytic nuclei particles to an appropriate location or locations in the flow system, and addresses a number of issues with conventional wax and/or hydrate seeding systems. Firstly, the multiple seeding points increase the likelihood of providing seeding optimised for both wax and hydrates, at or near to the WAT and HET. The system has improved robustness with respect to changes over time, changes in conditions, and error margins. A further advantage of the system is that it can be used effectively for new wells tied into subsea slots and templates at a later time, based on a standard or standardised design.

Additional benefits include effective operation with relatively low proportions of the transported fluid being recycled (for example, in the range of 0 to 30%) compared with previously proposed methods that rely on 50% to 100% recycling. The lower seeding rates mean that the method does not rely on shock cooling, and fluid return conduits can also be of correspondingly smaller nominal pipe size. The invention also enables a relatively small pump to be used in the fluid return conduit, which is lower in cost and requires less power to run. These features combine to provide a more efficient and compact cooler module that has lower capital and operating costs, and is easier to install.

A further benefit of the seeding apparatus and method is that the seeding nuclei and solid particles contained in the bulk fluid may effectively increase the erosion of deposited layers on the conduit system by impacting onto the layers.

Various modifications to the above-described embodiments may be made within the scope of the invention. For example, the valves 127 of the foregoing embodiments are isolation valves, configured to be operated in open or closed positions, but alternative embodiments may comprise flow control valves which are operable in partially open or partially closed positions to control a flow rate in their respective inlets. As such the valves may be partially opened/closed to adjust the flow rate at any given inflow position between a fully closed position and a fully open position. This enables control of seeding flow rate and the proportion of the fluid that is recycled through the system. In the majority of applications, a recycled fluid proportion of greater than 0% and up to 30% is desirable. Alternatively, or in addition, pump pressure may be controlled to adjust the seeding flow rate. In further variations to the described embodiments, recycled fluid may be injected into the heat exchange conduit to mix the recycled fluid into the bulk flow.

The coolers of the foregoing embodiments are shown as comprising a single heat exchange conduit between an inlet and an outlet, but it will be appreciated that other cooler configurations are within the scope of the invention, including but not limited to manifold coolers, spool coolers, shell-and-tube coolers, active and passive coolers, plate-coolers, and closed and open systems. In particular, a cooler apparatus of an embodiment of the invention comprises multiple heat exchange conduits arranged in parallel, each of similar form and function. Production fluid is then caused to flow through multiple heat exchange conduits in parallel, which increases the cooling capacity of the apparatus when required for the production fluid flow conditions. Flow into the multiple heat exchange conduits may be controlled by the provision of a manifold system with flow control valves, or by splitting the flow from a single inlet conduit. Such arrangements of parallel cooler conduits allow higher flow rates to be accommodated (for example during the early lifetime of a well), retaining throughput, without conduit diameters that create the desired turbulence in the fluid flowing through the cooler for effective operation. During a later time, if the flow rate of production fluid decreases, one or more of the cooler conduits can be taken offline. The reduction in flow area through the cooler system enables turbulent flow to be maintained at the lower production flow rate. Such parallel conduit systems could be configured as manifold flow coolers, spool coolers, helix coolers, and/or box coolers. In each case, each parallel cooler conduit would have a respective return line and secondary inlet system for seeding. The invention has application to cold flow systems, subsea coolers, and other coolers used generally to lower the temperature of a fluid and stimulate precipitation of solids upstream of items of processing equipment (to an extent required by that processing equipment).

Foregoing embodiments of the invention describe the use of measurements to verify and/or monitor performance of the system. In alternative modes of use, for example in the absence of sensors, a system operator would be able to detect a problem with flow from the well, and would be able to optimize the return seeding points to address the problem.

Variations to the described embodiments may include equipment for collecting and/or removing solids from flowing fluid in the system. Examples of possible equipment include solid-liquid separators such as cyclone units, configured to remove solids from the bulk flow of hydrocarbons. The solid removal equipment may include multiple units or stages in parallel or in series, and may operate continuously or semi-continuously. The equipment may be located at strategically selected parts of the flow system, for example upstream of equipment sensitive to solids in the flow such as compressors.

A further variation to the described examples may include systems or components for cleaning or otherwise mitigating against build-up of deposits on the return conduit, for example an internal pig, heat tracing elements, or a hot oil flushing system in accordance with prior art (see for example as disclosed in WO 2012/093079). These may be a part of the general cleaning system, or may be dedicated systems or components for the return conduit.

Alternative flow configurations may comprise an oil/water separator between the wellhead and the cooler inlet conduit, and water separated from the fluid by the separator may be discharged, transported, or reinjected into the well, or into a dedicated well for receiving produced water.

The invention extends to combinations of features other than those expressly described herein. In particular, features of the system 10, such as the upstream oil/water separator, pressure sensors, temperature sensors, a flow disrupting formation, inlet check valves, adjustable flow valves, and a cleaning system, are also applicable to the operation of the systems 100, 225, 325, and the method 500.

1. A cooler system for a hydrocarbon flow system, the cooler system comprising:
a heat exchange conduit comprising a primary inlet for receiving a fluid to be cooled and a primary outlet;
a return conduit, fluidly connected to the heat exchange conduit at a return location downstream of the primary inlet, and configured to direct at least a proportion of fluid in the heat exchange conduit from the return location to a secondary cooler inlet system;
wherein the secondary cooler inlet system enables inflow of recycled fluid from the return conduit to the heat exchange conduit at a plurality of inflow positions along the hydrocarbon flow system, upstream of the return location.

2. The cooler system according to claim 1, wherein the secondary cooler inlet system comprises a plurality of secondary cooler inlets configured to be located at a plurality of positions along a length of the hydrocarbon flow system, and each of the secondary cooler inlets enables inflow of return fluid to the hydrocarbon flow system at a different position along the length of the hydrocarbon flow system.

3. The cooler system according to claim 2, wherein the plurality of secondary cooler inlets comprises at least one secondary cooler inlet downstream of the primary inlet of the heat exchange conduit.

4. The cooler system according to claim 2, wherein the plurality of secondary cooler inlets comprises at least one secondary cooler inlet upstream of the primary inlet of the heat exchange conduit.

5. The cooler system according to claim 2, wherein the plurality of secondary cooler inlets comprises at least one secondary cooler inlet at or near to the primary cooler inlet.

6. (canceled)

7. The cooler system according to claim 1, wherein the secondary cooler inlet system comprises a plurality of secondary cooler inlets, and the secondary cooler inlet system is operable to provide inflow of return fluid at each of the plurality of secondary cooler inlets simultaneously or in parallel.

8. (canceled)

9. The cooler system according to claim 1, wherein the secondary cooler inlet system enables inflow of return fluid to the heat exchange conduit at a first position optimised for seeding of a wax compound from the fluid to be cooled, and a second position optimised for seeding of a hydrate compound from the fluid to be cooled.

10. The cooler system according to claim 1, wherein the secondary cooler inlet system comprises one or more flow control components for controlling inflow of return fluid to the one or more inflow positions.

11. (canceled)

12. The cooler system according claim 1, wherein secondary cooler inlet system is operable to change one or more inflow positions in response to one or more changed conditions of the apparatus and/or fluid to be cooled.

13. (canceled)

14. The cooler system according to claim 1, comprising one or more pressure sensors configured for measuring a pressure in the fluid to be cooled.

15. The cooler system according to claim 1, comprising one or more temperature sensors configured for measuring temperature at one or more positions along the length of the hydrocarbon flow system.

16. The cooler system according to claim 1, wherein the cooler apparatus comprises a cleaning system, configured to remove deposits of precipitated solids from the inner walls of the hydrocarbon flow system.

17. (canceled)

18. The cooler system according to claim 1, wherein the cooler system is a subsea cooler system.

19. A method of cooling a fluid in a hydrocarbon flow system, the method comprising:
flowing a fluid to be cooled through a cooler apparatus comprising a heat exchange conduit between a primary inlet and a primary outlet;
at a return location downstream of the primary inlet, directing at least a proportion of flowing fluid into a return conduit and to a secondary cooler inlet system;
wherein the secondary cooler inlet system enables inflow of recycled fluid from the return conduit at a plurality of inflow positions along the hydrocarbon flow system, upstream of the return location, and the method comprises flowing recycled fluid into the hydrocarbon flow system at one or more of the plurality of inflow positions.

20. The method according to claim 19, comprising flowing return fluid at a plurality of inflow positions along the hydrocarbon flow system simultaneously and/or in parallel.

21. The method according to claim 19, comprising selecting one or more inflow positions along the hydrocarbon flow system from the plurality of available inflow positions.

22. (canceled)

23. The method according to claim 19, comprising optimising the inflow position of a return fluid for seeding of a wax compound from the fluid to be cooled, and/or optimising the inflow position of a return fluid for seeding of a hydrate compound from the fluid to be cooled.

24. The method according to claim 19, comprising operating one or more valves to control the inflow of return fluid to the one or more inflow positions.

25. The method according to claim 19, comprising changing one or more inflow positions in response to a changed condition of the apparatus and/or fluid to be cooled.

26. (canceled)

27. The method according to claim 19, further comprising:
- monitoring the cooler apparatus via one or more pressure sensors;-
- measuring a pressure in the fluid to be cooled and/or a pressure differential across at least a portion of the apparatus;
- providing pressure data to a processor, and
- changing an inflow position based on processing or analysis of the pressure data.

28. (canceled)

29. The method according to claim 19, further comprising:
- monitoring the cooler apparatus via one or more temperature sensors;
- measuring a temperature at one or more positions along the length of the heat exchange cooler;
- providing temperature data to a processor, and;
- changing an inflow position based on processing or analysis of the temperature data.

30. (canceled)

31. A method of cooling a fluid in a hydrocarbon flow system, the method comprising:
flowing a fluid to be cooled through a cooler apparatus comprising a heat exchange conduit between a primary inlet and a primary outlet;
at a return location downstream of the primary inlet, directing at least a proportion of flowing fluid into a return conduit and to a secondary cooler inlet system;
flowing recycled fluid into the hydrocarbon flow system at a first one or more inflow positions during a first phase of operation; and
flowing recycled fluid into the hydrocarbon flow system at a second one or more inflow positions during a second phase of operation, the second one or more inflow positions along the hydrocarbon flow system being different from the first one or more inflow positions.

32. A method of configuring a cooler system for a hydrocarbon flow system, the cooler system comprising:
a heat exchange conduit comprising a primary inlet for receiving a fluid to be cooled and a primary outlet;
a return conduit, fluidly connected to the heat exchange conduit at a return location downstream of the primary inlet, and configured to direct at least a proportion of fluid in the heat exchange conduit from the return location to a secondary cooler inlet system;
wherein the secondary cooler inlet system enables inflow of recycled fluid from the return conduit to the heat exchange conduit at a plurality of inflow positions along the hydrocarbon flow system, upstream of the return location;
the method comprising:
inputting data to a processor module, the input data comprising:
fluid data relating to at least one characteristic of a fluid to be cooled; and
system data relating to the operation of the cooler system;
determining, using a cooler apparatus model running on the processor module and the input data, one or more inflow positions from the plurality of inflow positions along the hydrocarbon flow system.

33. The method according to claim 32, comprising changing the one or more inflow positions in dependence on the at least one characteristic of a fluid to be cooled.

34. (canceled)
